(19) United States
(12) Patent Application Publication
(10) Pub. No.: US 2025/0217134 A1
(43) Pub. Date: Jul. 3, 2025

(54) SOFTWARE APPLICATION PATCHING

(71) Applicant: Google LLC, Mountain View, CA (US)

(72) Inventor: Jason Kenneth O'Brien, Austin, TX (US)

(21) Appl. No.: 18/400,607

(22) Filed: Dec. 29, 2023

(51) Int. Cl. G06F 8/71

(52) U.S. Cl. CPC G06F 8/71

(57) ABSTRACT

Responsive to determining that a current version of an application is different from a prior version of the application installed at a computing device, a computing system generates a first graph for the current version and a second graph for the prior version. The first and second graphs include nodes indicative of data structures and edges indicative of references. The computing system pairs, using an algorithm, uniquely matching nodes between the first graph and the second graph. The algorithm is configured to iteratively hash the first graph and the second graph, and a set of unpaired nodes are updated incrementally with hashes of the paired uniquely matching nodes. The computing system generates a control file including encoded step functions based on edges associated with the set of unpaired nodes. The computing system generates, using the encoded step functions included in the control file, a mutated prior version of the application.

### BACKGROUND

Software developers may provide one or more application updates or “patches” to improve the functionality of an application. A patch may include one or more application elements, such as compiled source code (which can be executable code or various abstractions thereof, such as byte code), textures, images, animations, video files, audio files, or any other resource referenced by the executable code. In some distributed environments, a user computing device (e.g., a smartphone) may use an application store application (which may be referred to as an “application store”) to obtain and install patches, which are provided by a remote server computing system that supports execution of the application store.

In some examples, when a user selects an existing installed application on a user computing device to update, the user computing device may download a so-called “patch,” which contains all of the application updates. As such, the term “patch” may refer to a difference between the compiled source code and an updated version of the compiled source code, or a difference between a prior version of an application and a current or most recent version of the application. The user computing device may make a copy of the compiled source code (which may be a binary executable file) of the installed application and install the patch to the copy of the compiled source code to obtain the updated compiled source code. Such application update processes may require the user computing device to have enough storage space to store the compiled source code of the installed application, the patch (possibly twice when compression is employed as the compressed version of the patch requires decompression that may result in another decompressed version of the patch), and the updated compiled source code. Furthermore, these updates may require large amounts of network utilization, as several references between parts of the code file may call each other, and as a result, even trivial changes may have cascading effects across the references.

### SUMMARY

Techniques are described by which a computing system applies a patching algorithm for reducing the update size of strongly structured data with a high density of unstable intra-file references. As such, the amount of network utilization required for the installation of updates for a set of applications installed on a computing device, which may be connected to a data-limited network connection (e.g., a mobile data network), may be reduced. The computing system may determine that a current version of an application is different from a prior version of the application installed at a computing device. The computing system may apply a file-format-specific parser to the current version of the application and the prior version of the application to generate a first directed acyclic graph and a second directed acyclic graph (where nodes are data structures in the current and prior versions and edges are references between them). The computing system may apply a first algorithm (e.g., matching algorithm) to the first graph and the second graph to pair uniquely matching nodes between the first graph and the second graph. The first algorithm may additionally be configured to iteratively hash the first graph and the second graph, in which unpaired nodes are updated incrementally with hashes of the paired uniquely matching nodes. Specifically, the matching algorithm may iteratively hash both graphs to a fixed point, with unique matches being paired (and therefore fixed) and unpaired nodes being updated incrementally with the hashes of their newly matched successors, where both in-edges and out-edges provide context for alignment (e.g., two nodes with uniquely matching successors should be paired, and two uniquely matched nodes with remaining unpaired successors imply that those successors should be paired). The first algorithm may generate a control file including edges (i.e., in-edges and out-edges) encoded into step functions. The encoded step functions may indicate one or more differences between the references in the current version and the references in the prior version. The computing system may then apply the plurality of encoded step functions to the references in the prior version to generate a mutated prior version that closely matches the current version. In this way, the byte differences with the current version may be minimized. Additionally, the computing system may apply a second algorithm (e.g., a patching algorithm such as generic difference (diff) (“Gdiff”), bsdiff, Xdelta, VCDiff, or any other typical general-purpose patching algorithm) to the mutated prior version and the current version, in which the second algorithm may encode the remaining non-reference changes (e.g., code modifications) and correct any overly optimistic matches, and further generate a patch from the mutant prior version to the current version.

The computing system may send, to the computing device, the patch and the control file. The computing device may include a patch applier configured to read the plurality of encoded step functions included in the control file and, based on the patch, reproduce the mutated prior version.

The techniques described herein may reduce the update size of strongly structured data with a high density of unstable intra-file references by generating graphs representing data structures in files, as the graphs may replace the need for using direct byte sequences. Furthermore, references between the data structures (i.e., graph edges) may serve as useful context rather than provide harmful noise, as incidental changes to references may be efficiently encoded as step functions. Additionally, by managing updates over metered connections or data-limited network connections (e.g., a mobile data network) in accordance with techniques of this disclosure, the time required to complete such updates to applications may be reduced, while also reducing the impact on data caps and excess data usage fees incurred by downloading the application updates over the metered connection. Moreover, downloading and installing application updates over a metered or data-limited network connection in accordance with the techniques of this disclosure may aid in reducing crashes, security issues, or other bugs in such applications, thereby improving the operation of the computing device.

In some examples, a method includes: responsive to determining, by a computing system, that a current version of an application is different from a prior version of the application installed at a computing device, generating, by the computing system, a first graph for the current version of the application and a second graph for the prior version of the application, wherein the first graph includes nodes indicative of data structures in the current version and edges indicative of references in the current version, and wherein the second graph includes nodes indicative of data structures in the prior version and edges indicative of references in the prior version; pairing, by the computing system and using an algorithm, uniquely matching nodes between the first graph and the second graph, wherein the algorithm is configured to iteratively hash the first graph and the second graph, and wherein a set of unpaired nodes are updated incrementally with hashes of the paired uniquely matching nodes; generating, by the computing system and using the algorithm, a control file including a plurality of encoded step functions based on edges associated with the set of unpaired nodes; and generating, by the computing system and using the plurality of encoded step functions included in the control file, a mutated prior version of the application.

In some examples, a computing system includes: a memory; and one or more processors configured to: responsive to determining that a current version of an application is different from a prior version of the application installed at a computing device, generate a first graph for the current version of the application and a second graph for the prior version of the application, wherein the first graph includes nodes indicative of data structures in the current version and edges indicative of references in the current version, and wherein the second graph includes nodes indicative of data structures in the prior version and edges indicative of references in the prior version; pair, using an algorithm, uniquely matching nodes between the first graph and the second graph, wherein the algorithm is configured to iteratively hash the first graph and the second graph, and wherein a set of unpaired nodes are updated incrementally with hashes of the paired uniquely matching nodes; generate, using the algorithm, a control file including a plurality of encoded step functions based on edges associated with the set of unpaired nodes; and generate, using the plurality of encoded step functions included in the control file, a mutated prior version of the application.

In some examples, a non-transitory computer-readable storage medium encoded with instructions that, when executed by one or more processors of a computing system, cause the one or more processors to: responsive to determining that a current version of an application is different from a prior version of the application installed at a computing device, generate a first graph for the current version of the application and a second graph for the prior version of the application, wherein the first graph includes nodes indicative of data structures in the current version and edges indicative of references in the current version, and wherein the second graph includes nodes indicative of data structures in the prior version and edges indicative of references in the prior version; pair, using an algorithm, uniquely matching nodes between the first graph and the second graph, wherein the algorithm is configured to iteratively hash the first graph and the second graph, and wherein a set of unpaired nodes are updated incrementally with hashes of the paired uniquely matching nodes; generate, using the algorithm, a control file including a plurality of encoded step functions based on edges associated with the set of unpaired nodes; and generate, using the plurality of encoded step functions included in the control file, a mutated prior version of the application.

In some examples, a method includes: receiving, by a computing device and from a computing system, a patch and a control file, wherein the control file includes a plurality of encoded step functions indicating one or more differences between a prior version of an application installed at the computing device and a current version of the application; applying, by the computing device and using the control file, the patch to the prior version to reproduce a mutated prior version previously generated by the computing system; and applying, by the computing device and using an algorithm, the patch to the reproduced mutated prior version to generate the current version.

In some examples, a computing device includes: a memory; and one or more processors configured to: receive, from a computing system, a patch and a control file, wherein the control file includes a plurality of encoded step functions indicating one or more differences between a prior version of an application installed at the computing device and a current version of the application; apply, using the control file, the patch to the prior version to reproduce a mutated prior version previously generated by the computing system; and apply, using an algorithm, the patch to the reproduced mutated prior version to generate the current version.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing system and computing device for managing the size of application updates, in accordance with techniques of this disclosure.

FIG. 2 is a block diagram illustrating an example computing system for managing the size of application updates, in accordance with techniques of this disclosure.

FIG. 3 is a block diagram illustrating an example computing device for managing the size of application updates, in accordance with techniques of this disclosure.

FIG. 4 is a flowchart illustrating an exemplary operation of the computing system, in accordance with techniques of this disclosure.

FIG. 5 is a flowchart illustrating an exemplary operation of the computing device, in accordance with techniques of this disclosure.

### DETAILED DESCRIPTION

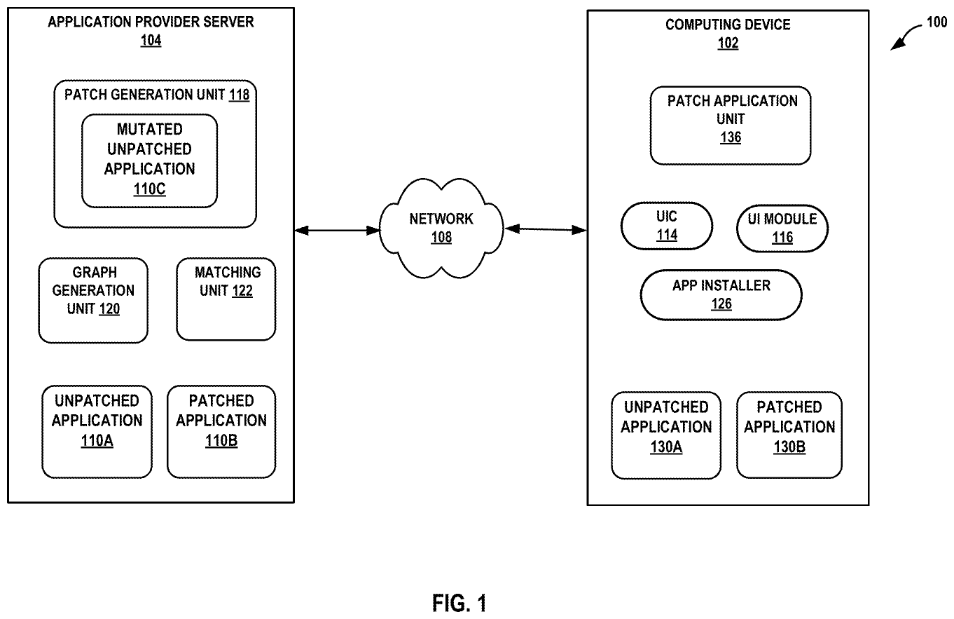

FIG. 1 is a conceptual diagram illustrating an example computing system and computing device for managing the size of application updates, in accordance with techniques of this disclosure. Shown in the example of FIG. 1 is a computing system 100 that may facilitate management of application updates by applying a patching algorithm, in which the patching algorithm may reduce the update size of strongly structured data with a high density of unstable intra-file references, in accordance with one or more techniques of this disclosure.

As shown in FIG. 1, computing system 100 may include a computing device 102 and an application provider server 104. In some examples, some or all of the components and/or functionality attributed to computing system 100 and/or application provider server 104 may be implemented or performed by computing device 102. Computing device 102 may represent any type of device capable of executing applications, such as application 130 (which is represented as unpatched application 130A and patched application 130B in the example of FIG. 1), and supports application of software patches (which may also be referred to as “patches”) to such applications. While not explicitly shown in the example of FIG. 1, computing device 102 may represent a plurality of computing devices that may include, but are not limited to, a cellular phone or handset (including a so-called “smart phone”), a streaming media device (including those that are inserted directly into a port of a television), a dedicated gaming system, a portable gaming system, a streaming gaming system, a television (including so-called “smart televisions”), a wireless speaker, a smart hub, a watch (including a so-called “smart watch”), smart glasses, a smart ring or other wearable device, an extended reality device (such as a virtual reality—VR—device, an augmented reality—AR—device, etc.), a digital video disc (DVD) player, a Blu-ray™ player, a laptop computer, a desktop computer, a workstation an e-book reader, an add-on device (such as a casting device), a gaming controller, or any other device capable of executing applications. In some examples, computing device 102 may be a vehicle computing device, such as a head unit or other vehicular computing system (such as an electronic control unit—ECU). In these examples, processors of computing device 102 may retrieve and execute an operating system (OS), which may be referred to as an embedded OS in that the OS is a fully specified OS that provides a full-featured application execution environment, in which local applications (such as the applications described herein) may be stored locally (e.g., to a storage device of computing device 102) and executed by processors within the execution environment provided by the OS. In these examples, computing device 102 may include a presence-sensitive display, or a built-in component located within and physically connected to the external packaging of computing device 102 (e.g., an in-vehicle screen mounted or integrated in a dashboard of a vehicle). In another example, a presence-sensitive display may be an external component of computing device 102 located outside and physically separated from the packaging of computing device 102 (e.g., a monitor, a projector, etc. that shares a wired and/or wireless data path with an electronic control unit of the vehicle).

As shown in the example of FIG. 1, computing device 102 includes a user interface component (UIC) 114, UI module 116, an application installer 126, patch application unit 136, and, prior to receiving a patch for application 130, unpatched application 130A. UIC 114 of computing device 102 may function as an input and/or output device for computing device 102. UIC 114 may be implemented using various technologies. For instance, UIC 114 may function as an input device using a presence-sensitive input component, such as a resistive touchscreen, a surface acoustic wave touchscreen, a capacitive touchscreen, a projective capacitive touchscreen, a pressure sensitive screen, an acoustic pulse recognition touch screen, or another presence-sensitive display technology. The presence-sensitive display may function as an output (e.g., display) device using any of one or more display components, such as a liquid crystal display (LCD), dot matrix display, light emitting diode (LED) display, microLED display, organic light-emitting diode (OLED) display, e-ink, active matrix organic light-emitting diode (AMOLED) display, or similar monochrome or color display capable of outputting visible information to a user of computing device 102.

UI module 116 may manage user interactions with UIC 114 and other components of computing device 102. UIC 114 and UI module 116 may receive one or more indications of input (e.g., voice input, gesture input, etc.) from a user as the user interacts with a user interface presented by UIC 114 (e.g., when a user interacts with a user interface of an application store application supported by computing device 102).

Application 130 of computing device 102 may represent a first party application developed and provided as an application integrated into an operating system or third-party application that a user of computing device 102 obtains via application store services provided by way of the operating system, application provider server 104, or another computing system. Application 130 may extend software functionality of computing device 102, where application 130 may execute within an execution environment presented by the operating system. Application 130 may, as a few examples, provide gaming services (e.g., video games), email services, web browsing services, texting and/or chat services, web conferencing services, video conferencing services, music services (including streaming music services), video services (including video streaming services), navigation services, word processing services, spreadsheet services, slide and/or presentation services, assistant services, text entry services, or any other service commonly provided by applications.

As described herein, unpatched application 130A may represent a prior version of application 130 that is currently installed on computing device 102. Specifically, unpatched application 130A may be a version of application 130 that is different from a current version or most recent version of application 130, such as patched application 130B. While a current version and a prior version of an application may be referred to herein as a “patched application” and an “unpatched application”, respectively, it should be understood that the patched application(s) and unpatched application(s) described herein may each include one or more files including one or more file formats, as well as metadata required for the installation and functioning of an application. Furthermore, while the techniques of this disclosure are described herein with respect to “patched application(s)” and “unpatched application(s)”, it should be understood that the techniques described herein may be applied to specific file formats and metadata included in the patched application(s) and unpatched application(s) at various points in time.

While both unpatched application 130A and patched application 130B are shown in the example of FIG. 1, it should be understood that computing device 102 may not include patched application 130B until a patch is applied to unpatched application 130A that produces patched application 130B. Additionally, while the example of FIG. 1 illustrates a single application 130 that is currently installed on computing device 102, it should be understood that any number of applications may be installed on computing device 102, that computing device 102 is not necessarily limited to only having a single application installed on computing device 102, and that the techniques of this disclosure may be applied to any number of applications installed on computing device 102.

UIC 114, UI module 116, application installer 126, patch application unit 136, and application 130 may perform operations described herein using hardware, or a combination of hardware and software and/or firmware residing in and/or executing at computing device 102. Computing device 102 may execute UI module 116, application installer 126, patch application unit 136, and application 130 with multiple processors or multiple devices. In some cases, computing device 102 may execute UI module 116 and/or application installer 126 as virtual machines executing on underlying hardware. UI module 116 and/or application installer 126 may also execute as one or more services of an operating system or computing platform, or as one or more executable programs at an application layer of a computing platform.

As further shown in the example of FIG. 1, computing device 102 may communicate with application provider server 104 via network 108, where network 108 may represent any public or private communications network, for instance, cellular, Wi-Fi, and/or other types of networks, for transmitting data between computing systems, servers, and computing devices. Network 108 may include one or more network hubs, network switches, network routers, or any other network equipment, that are operatively inter-coupled thereby providing for the exchange of information between application provider server 104 and computing device 102. Network 108 may include a wide-area network such as the Internet, a local-area network (LAN), a personal area network (PAN) (e.g., Bluetooth®), an enterprise network, a wireless network, a cellular network, a telephony network, a Metropolitan area network (e.g., WIFI, WAN, WiMAX, etc.), one or more other types of networks, or a combination of two or more different types of networks (e.g., a combination of a cellular network and the Internet). Computing device 102 and application provider server 104 may transmit and receive data across network 108 using any suitable communication techniques. For example, computing device 102 and/or application provider server 104 may include wireless communication devices capable of transmitting and/or receiving communication signals using network 108, such as a cellular radio, a 3G radio, a 4G radio, a 5G radio, a Bluetooth® radio (or any other PAN radio), an NFC radio, or a WIFI radio (or any other WLAN radio). Additionally, or alternatively, computing device 102 and/or application provider server 104 may include wired communication devices capable of transmitting and/or receiving communication signals via a direct link over a wired communication medium (e.g., a universal serial bus (“USB”) cable). The links coupling computing device 102 and application provider server 104 to network 108 may be Ethernet or other types of network connections and such connections may be wireless and/or wired connections.

Application provider server 104 may represent any suitable remote computing system, such as one or more desktop computers, laptop computers, mainframes, servers, cloud computing systems, etc. capable of sending and receiving information both to and from a network, such as network 108. In some examples, application provider server 104 may represent a cloud computing system that provides one or more services via network 108. That is, in some examples, application provider server 104 may be a distributed computing system. One or more computing devices, such as computing device 102, may access the services provided by the cloud by communicating with application provider server 104. While described herein as being performed at least in part by application provider server 104, any or all techniques of the present disclosure may be performed by one or more other devices, such as computing device 102. That is, in some examples, computing device 102 may be operable to perform one or more techniques of the present disclosure alone.

Application provider server 104 may host (or at least provides access to) applications and present the above noted interface (such as an application store, which is not shown in the example of FIG. 1 for ease of illustration purposes) by which computing device 102 may access applications, such as application 130, for download to computing device 102 via network 108. Application provider server 104 may perform operations described using hardware or a mixture of hardware, software, and firmware residing in and/or executing at application provider server 104. Application provider server 104 may perform various operations described herein with multiple processors or multiple devices. Application provider server 104 may also execute various modules or units described in more detail below as virtual machines executing on underlying hardware. In some examples, application provider server 104 may execute the interface by which to access applications as one or more services of an operating system or computing platform, or as one or more executable programs at an application layer of a computing platform.

As described herein, computing devices such as computing device 102 may be equipped with operating systems which permit the devices to execute a wide range of computer programs and software applications. In some examples, a user of computing device 102 may download, install, and execute one or more applications by direct communication (e.g., using one or more of UIC 114) with application provider server 104 (e.g., a server hosting an application store) through network 108. Developers may regularly update applications and push the updated version of an application to application provider server 104, such that the updated version of the application is made available for installation by computing device 102. As shown in FIG. 1, application provider server 104 includes application 110 (shown in the example of FIG. 1 as unpatched application 110A and patched application 110B). Unpatched application 110A may represent a prior version of application 110, while patched application 110B may represent a current version of application 110. As described herein, unpatched application 130A of computing device 102 may represent a different instance of unpatched application 110A of application provider server 104, and patched application 130B of computing device 102 may represent a different instance of patched application 110B of application provider server 104. For example, unpatched application 110A may represent or be equivalent to the non-updated or a prior version of application 130 installed at computing device 102, or unpatched application 130A. As such, application 110 and application 130 may be the same application, and application provider server 104 may continuously update unpatched application 110A to match the most recent version of application 130 installed at computing device 102.

As described herein, application provider server 104 may determine that a current version of application 110 (e.g., patched application 110B, which may be provided to application provider server 104 by developers) is different from a prior version of application 110 (e.g., unpatched application 110A) installed at a computing device (in which application 110 is installed at computing device 102 as application 130, and unpatched application 110A represents unpatched application 130A). Responsive to determining that a current version of an application (e.g., patched application 110B) is different from a prior version of the application installed at a computing device (e.g., patched application 110A), application provider server 104 may perform the techniques described herein such that the prior version of application 130 installed at computing device 102 (e.g., unpatched application 130A) is updated to the current version of application 130 (e.g., patched application 130B).

Each of unpatched application 110A, patched application 110B, unpatched application 130A, patched application 130B and any other patched or unpatched applications described herein may represent compiled source code (or, in other words, executable binary code or some derivation thereof, such as byte code) or another type of file, resource, and/or data that configures or otherwise programs a processor (or other hardware) to perform various operations. Developers may update “assets” or features of unpatched application 110A (which again may be an instance of unpatched application 130A) to improve graphical fidelity, update textures, add or remove video data and/or audio data, or perform other example updates that improve a user experience of application 110. As such, patched application 110B may include a set of assets or features that is different from a set of assets or features included in unpatched application 110A (and thus patched application 130B may include a set of assets or features that is different from a set of assets or features included in unpatched application 130A).

As described herein, in some instances, due to the patching process, computing device 102 may have insufficient storage space (e.g., memory and/or storage space) to store unpatched application 130A, patched application 130B, and a patch that updates unpatched application 130A to patched application 130B. In other words, to apply a patch, computing device 102 may download the patch in its entirety and reserve available space in memory and/or storage for patched application 130B, all while storing unpatched application 130A in its entirety. Furthermore, in some instances, downloading and applying the patch in its entirety may require large amounts of network utilization, as the patch may be large (on the order of multiple gigabytes—e.g., several to tens of gigabytes, multiple megabytes—e.g., hundreds of megabytes, etc.). Even in instances of minor updates several references between parts of compiled source code files may call each other, and as a result, cause cascading effects across the references that result in a large minimum patch size (e.g., adding or removing a small class could invalidate nearly all pointers; removal of <1 kB of code may lead to a patch size of 1 MB or more). For example, the addition of a single logging statement has been observed to modify about one-third of the bytes in the resulting file. For example, removing a single logging call results in one less string, and therefore a reindexing of subsequent strings by one (assuming a relatively stable toolchain), thus invalidating subsequent references to those strings, all method signature references (addressed by file offset), etc. This issue may be evident in certain types of compiled code, and particularly in file formats that are reference-dense (e.g., formats including several large data segments or structures composed entirely of intra-file references (by byte offset or element index)). While some modern patching algorithms may afford some noise when matching new and old byte sequences, they may not be able to perform well on file formats that are reference-dense, as they may be unlikely to find any mostly-identical byte sequences, or gain insight from the implicit relationship between the source and target. As such, modern patching algorithms may encode certain data structures as delete and insert, and thus are effectively unpatched. Furthermore, these issues may result in further complications for applications which receive frequent updates, as each update may be similarly expensive regardless of frequency, saturation of critical bug fixes, which tend to be small (e.g., one-line) changes, and devices which use (or would like to use) a small budget of metered data for application updates.

As described herein, application provider server 104 may reduce the patch size of application 130, which may comprise strongly structured data with a high density of unstable intra-file references, by generating graphs representing data structures, as the graphs may replace the need for using direct byte sequences. In some examples, the techniques described herein may reduce update size by over 70%. As shown in the example of FIG. 1, application provider server 104 includes a graph generation unit 120. Responsive to determining that patched application 110B is different from unpatched application 110A, application provider server 104 may execute graph generation unit 120 to generate a first graph for the current version of the application (e.g., patched application 110B) and a second graph for the prior version of the application (e.g., unpatched application 110A). The first graph may include nodes indicative of data structures in the current version (e.g., patched application 110B) and edges indicative of references in the current version (e.g., patched application 110B), and the second graph may include nodes indicative of data structures in the prior version (e.g., unpatched application 110A) and edges indicative of references in the prior version (e.g., unpatched application 110A).

Application provider server 104 may further include matching unit 122, which may be configured to implement an algorithm, such as a matching algorithm, to pair uniquely matching nodes between the first graph and the second graph generated by graph generation unit 120. Furthermore, in some examples, the algorithm applied by matching unit 122 may be configured to iteratively hash the first graph and the second graph, in which a set of unpaired nodes are updated incrementally with hashes of the paired uniquely matching nodes. Matching unit 122 may further generate a control file including a plurality of encoded step functions based on edges associated with the set of unpaired nodes. Specifically, the plurality of encoded step functions may indicate one or more differences between the references in unpatched application 110A and the references in patched application 110B.

As described herein, application provider server 104 may generate, using the plurality of encoded step functions included in the control file, a mutated unpatched application 110C. Specifically, patch generation unit 118 of application provider server 104 may apply the plurality of encoded step functions to the references in unpatched application 110A to generate mutated unpatched application 110C. Patch generation unit 118 may also apply an algorithm (e.g., patching algorithm) to mutated unpatched application 110C and patched application 110B to generate a patch. Application provider server 104 may then send, to computing device 102, the patch and the control file, in which patch application unit 136 of computing device 102 is configured to read the plurality of encoded step functions included in the control file and, based on the patch, reproduce mutated unpatched application 110C, in which computing device 102 may then execute a patching algorithm to apply the patch and produce patched application 130B.

Application installer 126 may represent a module or unit configured to install application 130 on computing device 102. Application installer 126 may also present an interface provided by application provider server 104 with which the user of computing device 102 may interact via UIC 114 and/or UI module 116 to download a patch for unpatched application 130A. Application installer 126 may communicate with application provider server 104 to arrange for the download of the patch, where application installer 126 may, upon receiving the patch, perform various operations to install patched application 130B, such as decompressing (which may be referred to as “unzipping”), memory management, etc.

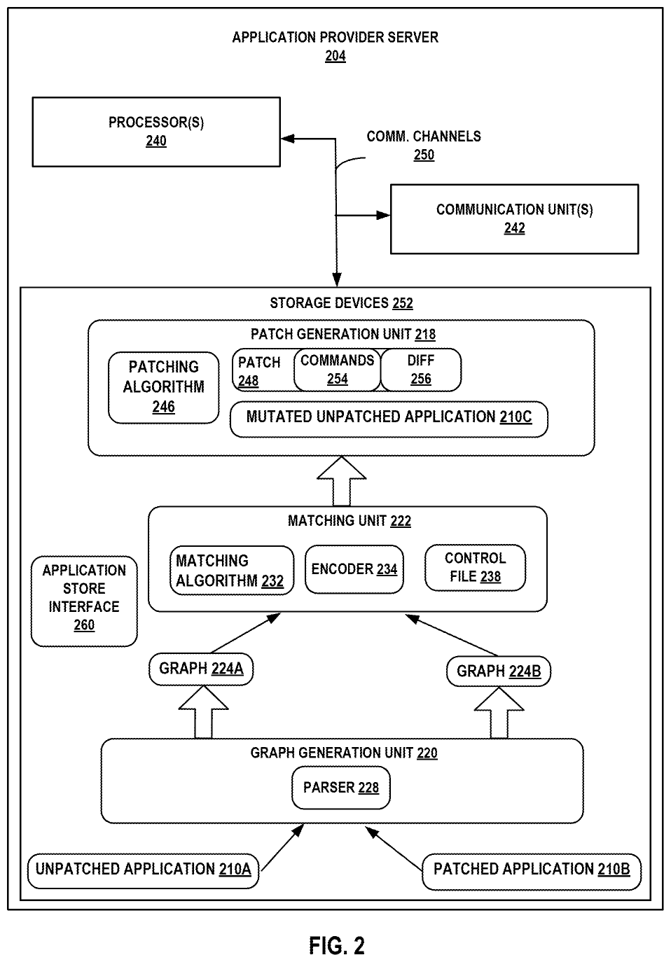

FIG. 2 is a block diagram illustrating an example computing system for managing the size of application updates, in accordance with techniques of this disclosure. FIG. 2 illustrates only one particular example of application provider server 204, and many other examples of application provider server 204 or other computing systems may be used in other instances. In other examples, application provider server 204 may include a subset of the components included in example application provider server 104 of FIG. 1 or may include additional components not shown in FIG. 2. For example, application provider server 204 may comprise a cluster of servers, and each of the servers comprising the cluster of servers making up application provider server 204 may include all, or some, of the components described herein with respect to FIG. 2, to perform the techniques disclosed herein. As such, application provider server 204 of FIG. 2 represents one example of application provider server 104 of FIG. 1.

As shown in the example of FIG. 2, application provider server 204 includes one or more processors 240, one or more communication units 242, and one or more storage devices 252, each of which are interconnected by communication channels 250. Processors 240 may implement functionality and/or execute instructions associated with application provider server 204. Examples of processors 240 include application processors, display controllers, auxiliary processors, one or more sensor hubs, and any other hardware configured to function as a processor, a processing unit, or a processing device. Unpatched application 210A, patched application 210B, graph generation unit 220, matching unit 222, patch generation unit 218 (all of which may similar, if not substantially similar to unpatched application 110A, patched application 110B, graph generation unit 120, matching unit 122, and patch generation unit 118 of FIG. 1, respectively), graph 224A, graph 224B, and an application store interface 260 may be operable or executed by processors 240 to perform various actions, operations, or functions of application provider server 204. For example, processors 240 may retrieve and execute instructions stored by storage devices 252 (and represented by unpatched application 210A, patched application 210B, graph generation unit 220, matching unit 222, patch generation unit 218, graph 224A, graph 224B, and application store interface 260) that cause processors 240 to perform the operations described herein with respect to graph unpatched application 210A, patched application 210B, graph generation unit 220, matching unit 222, patch generation unit 218, graph 224A, graph 224B, and application store interface 260. The instructions, when executed by processors 240, may cause application provider server 204 to store information within storage devices 252.

Communication unit 242 may represent a unit configured to communicate with external devices (e.g., computing device 102 of FIG. 1) via one or more wired and/or wireless networks (e.g., network 108 of FIG. 1) by transmitting and/or receiving network signals via the one or more networks. Examples of communication units 242 include a network interface card (e.g., such as an Ethernet card), an optical transceiver, a radio frequency transceiver, a global positioning satellite (GPS) receiver, a cellular transceiver, or any other type of device that can send and/or receive data. Other examples of communication units 242 may include short wave radios, cellular data radios, wireless network radios, as well as universal serial bus (USB) controllers.

Storage devices 252 may represent one or more memories and/or storage devices configured to store information for processing during operation of application provider server 204. In some examples, storage devices 252 may represent a temporary memory, meaning that a primary purpose of storage devices 252 is not long-term storage. Storage devices 252 may be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art.

Storage devices 252 may, in some examples, also include one or more computer-readable storage mediums. Storage devices 252 may include one or more non-transitory computer-readable storage mediums. Storage devices 252 may be configured to store larger amounts of information than typically stored by volatile memory. Storage devices 252 may further be configured for long-term storage of information as non-volatile memory space and retain information after power on/off cycles. Examples of non-volatile memories include magnetic hard disks, optical discs, floppy discs, flash memories, or forms of electrically programmable memories (EPROM) or electrically erasable and programmable (EEPROM) memories. Storage devices 252 may store program instructions and/or information (e.g., data) associated with unpatched application 210A, patched application 210B, graph generation unit 220, matching unit 222, patch generation unit 218, graph 224A, graph 224B, and application store interface 260. Storage devices 252 may include a memory configured to store data or other information associated with unpatched application 210A, patched application 210B, graph generation unit 220, matching unit 222, patch generation unit 218, graph 224A, graph 224B, and application store interface 260.

Application provider server 204 may initially receive, via application store interface 260 (which may represent an interface presented to software developers, users, and other entities for interacting with an underlying electronic marketplace for downloading or otherwise obtaining applications) patched application 210B from a software developer responsible for supporting application 210 (which may be similar if not substantially similar to application 110 of FIG. 1). In some examples, application provider server 204 may invoke graph generation unit 220 on unpatched application 210A and patched application 210B to generate graphs 224A and 224B responsive to receiving patched application 210B. In some examples, responsive to determining that patched application 210B is different from unpatched application 210A, application provider server 204 may invoke graph generation unit 220 on unpatched application 210A and patched application 210B to generate graphs 224A and 224B. Graph 224A may be representative of unpatched application 210A and graph 224B representative of patched application 210B. Specifically, graph generation unit 220 may apply parser 228 to unpatched application 210A and patched application 210B to generate graph 224A and graph 224B, respectively. In some examples, parser 228 is a file-format-specific parser. In some examples, each of graph 224A and graph 224B is a directed acyclic graph for file formats. As described herein, a directed acyclic graph may be a data structure that consists of nodes connected by directed edges, in which there are no cycles in the graph. Each node in the directed acyclic graph may represent an entity or a component of the file, and the edges may represent relationships or dependencies between these entities. As described herein, graph 224B may include nodes indicative of data structures in patched application 210B and edges indicative of references in patched application 210B, and graph 224A may include nodes indicative of data structures in unpatched application 210A and edges indicative of references in unpatched application 210A.

Thus, because graphs 224A and 224B may represent data structures in unpatched application 210A and patched application 210B, respectively, alignment may occur on graphs 224A and 224B rather than on direct byte sequences of code files. As such, references between the structures (i.e., graph edges) may serve as useful context, rather than be harmful noise. While other algorithms may leverage techniques to handle references better than plain data, e.g., by delta-encoding them or isolating them from more stable data, alignment on graphs, and specifically directed acyclic graphs for file formats, may be much more effective when the density of noisy references becomes high enough that these algorithms are unable to match the surrounding byte sections.

Graphs 224A and graphs 224B may be provided to matching unit 222. Matching unit 222 may apply an algorithm (e.g., matching algorithm 232) to graphs 224A and 224B to pair (e.g., align) uniquely matching nodes (e.g., equivalent nodes such as compiled methods, identical constants, etc.) between graphs 224A and 224B. Matching algorithm 232 may include one or more of a maximum cardinality matching algorithm, maximum weight matching algorithm, stable marriage problem (Gale-Shapley algorithm), bipartite matching (Hopcroft-Karp algorithm), topological matching, interval graph matching, tree matching, or any other algorithm or matching configured for finding pairs of nodes or vertices. In some examples, matching algorithm 232 may pair at least two unpaired nodes in graphs 224A and 224B with uniquely matching successors, and pair at least two unpaired successors of at least two paired uniquely matching nodes in graphs 224A and 224B. Matching algorithm 232 may additionally be configured to iteratively hash graphs 224A and 224B, in which unpaired nodes are updated incrementally with hashes of the paired uniquely matching nodes. Both in-edges and out-edges of graphs 224A and 224B may provide context for alignment (e.g., two nodes with uniquely matching successors should be paired, and two uniquely matched nodes with remaining unpaired successors imply that those successors should be paired).

More specifically, matching algorithm 232 may be configured to implement recursive hashing, in which matching algorithm 232 may calculate a value hash of every node's non-reference data (e.g., a node representing a string will contain a hash of that string). Matching algorithm 232 may then calculate a reference hash for every node based on its value hash and the reference hashes of the nodes it depends on. Matching algorithm 232 may ignore cyclical references. Matching algorithm 232 may then pair any unique hash matches between graph 224A and graph 224B. Matching algorithm 232 may then iteratively hash graphs 224A and 224B to a fixed point, e.g., matching algorithm 232 may repeat calculations of reference hashes for every node based on its value hash and the reference hashes of the nodes it depends on, until there are no effective updates or an upper bound (e.g., small single digit) on iterations has been reached. As described herein, pairing two nodes may involve replacing them in their respective graph with surrogate nodes sharing a unique value, and pairing their children, which are already implied to match (possibly non-uniquely) in the order in which the references appeared. As such, reverse edges may participate in matching. For example, given two large, uniquely matching method bytecode segments, one can infer that the fields they reference are also equivalent.

Once pairing has terminated, unit 222 may record all pairs as deltas in a corresponding step function. Matching unit 222 may further include an encoder 234 configured to encode edges (i.e., in-edges and out-edges) into step functions. The encoded step functions generated by encoder 234 may indicate one or more differences between the references in unpatched application 210A and patched application 210B, or graph 224A and graph 224B. Specifically, encoder 234 may efficiently encode incidental changes to references included in unpatched application 210A and patched application 210B (e.g., string at index #3 in unpatched application 210A has moved to index #5 in patched application 210B) as step functions. As the file formats of unpatched application 210A and patched application 210B may have high “pointer” content, or sequence references that tend to be wholly invalidated with even trivial changes, the transformation of these pointers may be far more efficiently encoded as stepwise transformations of numerical sequences, as compared to a general diff algorithm.

For example, encoding the references as step functions may result in less redundancy. Specifically, by encoding each reference sequence (e.g., “string indices” or “file byte offsets”) as a step function of deltas from the references in unpatched application 210A, and removing redundant values, the redundancy of the patch generated by patch generation unit 218 may be greatly reduced. For example, in an example of adding N chunks to a file with M offset references, the patch is O(min (N, M)), instead of O(M), which can be extremely efficient for small changes to large files.

Matching unit 222 may generate control file 238 that includes the encoded step functions. Control file 238, as described herein, may also include metadata or contextual data that can be processed by a general-purpose patching algorithm, such as patching algorithm 246, in order to gain insights from the implicit relationships between a source and target. As such, patching algorithm 246 may not encode as many pointer-rich deltas as insert/delete. Control file 238 may be provided to computing device 102 and include all data or information required for reproducing mutated unpatched application 210C, which may be described in more detail below.

Control file 238 may be provided to patch generation unit 218 to generate mutated unpatched application 210C. Specifically, patch generation unit 218 may apply the plurality of encoded step functions included in control file 238 to the references in unpatched application 210A to generate a mutated unpatched application 210C, in which mutated unpatched application 210C may include references that closely match the references in patched application 210B. In this way, the byte differences with patched application 210B may be minimized.

In some examples, patch generation unit 218 may apply patching algorithm 246, which may be a typical general-purpose patching algorithm, to generate patch 248. Patch 248, as described herein, may be may representative of one or more differences between mutated unpatched application 210C and patched application 210B, or may be may representative of one or more differences between the compiled source code of mutated unpatched application 210C and an updated or current version of the compiled source code, or patched application 210B. In some examples, patch 248 may be considered a per-file patch, or a file or set of instructions that describes differences between two versions of a file (e.g., a prior version and a current version of an application file).

In some examples, patching algorithm 246 is configured to encode one or more differences not between the references in unpatched application 210A and patched application 210B, or the remaining non-reference changes (e.g., code modifications). In this way, patching algorithm 246 may correct any overly optimistic matches made by matching unit 222.

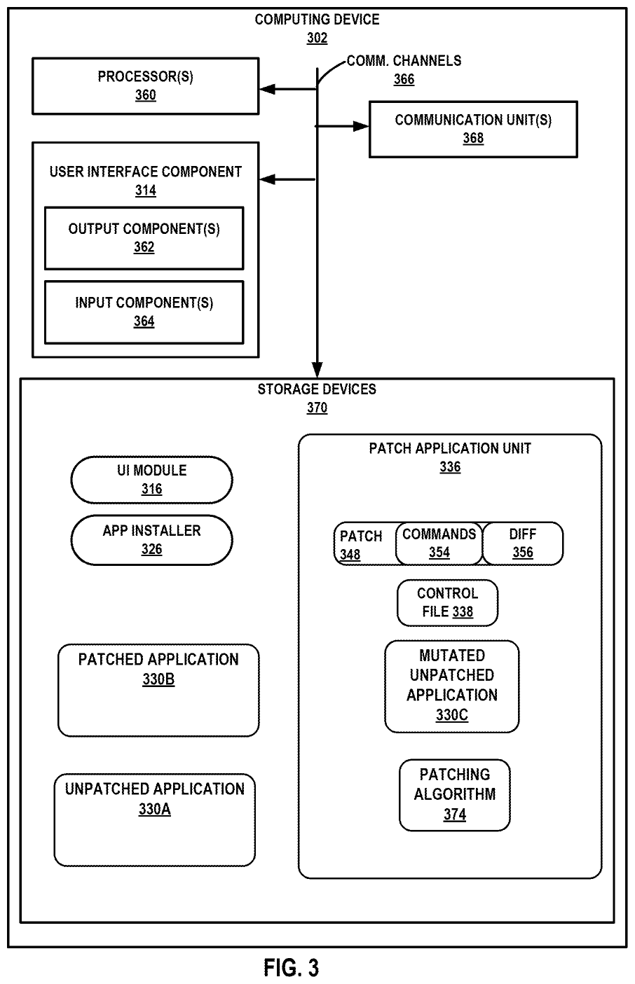

Patch generation unit 218 may execute patching algorithm 246, which may be one or more patching algorithms configured to generate patch 248, such as generic difference (diff) (“Gdiff”), bsdiff, Xdelta, Diff, VCDiff, or any other typical general-purpose patching algorithm, which may generate and potentially compress (along with other operations performed with respect to the unpatched and patched applications or files described herein) the underlying binary differences between mutated unpatched application 210C and patched application 210B to form patch 248. Patch generation unit 218 may represent a unit configured to determine a difference between mutated unpatched application 210C and patched application 210B, and output a list of commands 254 for updating mutated unpatched application 210C to patched application 210B and difference 256 (“diff 256”) that both form patch 248. Commands 254 may identify one or more delete operations, one or more copy operations, and/or one or more of write operations (or any combinations thereof) instructing computing device 102 of FIG. 1 how to manipulate an unpatched application to produce a patched application. In some examples, computing device 102 may iterate through commands 254 of patch 248 to perform one or more of the above operations to construct a mutated unpatched application from an unpatched application and diff 256. In some examples, computing device 102 may iterate through commands 254 of patch 248 to additionally construct a patched application (e.g., patch application 130B) from an unpatched application or the mutated unpatched application (e.g., mutated unpatched application 330C of FIG. 3) and diff 256. As described above, provided that mutated unpatched application 210C may already closely match patched application 210B, the size of patch 248 and commands 254 may be minimized. In this way, application provider server 204 may reduce the update size of applications installed on computing devices.

In some examples, patch generation unit 218 may output patch 248, whereupon application provider server 204 may interface to alert computing device 102 of patch 248. Computing device 102 may then request patch 248 from application provider server 204 via the above noted interface, invoking app installer 126 to download and install patch 248. In some examples, responsive to the request for patch 248, application provider server 204 may segment patch 248 into one or more patch segments such that some subset of commands 254 and corresponding portion of diff 256 are completely contained within each segment.

In examples in which segments of patch 248 are generated and applied, patch generation unit 218 may generate, while obtaining patch 248, metadata indicating when computing device 102 is able to delete portions of unpatched application 130A of FIG. 1. Patch generation unit 218 may generate metadata as a series of one or more instructions, each of which may include a read index followed by an indication identifying an associated portion of unpatched application 130A. Patch generation unit 218 may systematically generate metadata in this manner to indicate when portions of unpatched application 130A may be deleted (or, in other words, marked as available memory and/or storage). Application provider server 204 may send the metadata to computing device 102 with respective patch segments. In some examples, application provider server 204 may include the metadata in control file 238. As such, deletion of portions of an unpatched application may be permitted during application of patch 248 to an unpatched application, which may further reduce memory utilization and thereby improve the performance of computing device 102.

Although the example of FIG. 2 includes matching algorithm 232 and patching algorithm 246, application provider server 204 may be configured to apply one or more other algorithms or machine learning models not shown in the example of FIG. 2. For example, application provider server 204 may perform regression, clustering, anomaly detection, and/or other tasks. In some examples, application provider server 204 may perform regression to provide output data in the form of a continuous numeric value. The continuous numeric value may correspond to any number of different metrics or numeric representations, including, for example, currency values, scores, or other numeric representations. As examples, application provider server 204 may perform linear regression, polynomial regression, or nonlinear regression. As examples, application provider server 204 may perform simple regression or multiple regression. As described above, in some examples, a Softmax function or other function or layer may be used to squash a set of real values respectively associated with two or more possible classes to a set of real values in the range (0, 1) that sum to one.

Application provider server 204 may perform various types of clustering. For example, application provider server 204 may identify one or more previously defined clusters to which the input data most likely corresponds. Application provider server 204 may identify one or more clusters within the input data. That is, in instances in which the input data includes multiple objects, documents, or other entities, application provider server 204 may sort the multiple entities included in the input data into a number of clusters. In some examples in which application provider server 204 applies one or more models to perform clustering, the one or more models may be trained using unsupervised learning techniques.

Application provider server 204 may perform anomaly detection or outlier detection. For example, application provider server 204 may identify input data that does not conform to an expected pattern or other characteristic (e.g., as previously observed from previous input data). As examples, the anomaly detection may be used for detecting failures to install application updates.

In some examples, application provider server 204 may include a model trainer that trains one or more models included in application provider server 204 in an offline fashion or an online fashion. In offline training (also known as batch learning), one or more models implemented by application provider server 204 may be trained on the entirety of a static set of training data. In online learning, the one or more models may be continuously trained (or re-trained) as new training data becomes available (e.g., as new information about application usage, installation history, and context is generated). The model trainer may perform centralized training of the one or more models (e.g., based on a centrally stored dataset). In other examples, decentralized training techniques such as distributed training, federated learning, or the like may be used to train, update, or personalize one or more models implemented by application provider server 204.

FIG. 3 is a block diagram illustrating an example computing device for managing the size of application updates, in accordance with techniques of this disclosure. FIG. 3 illustrates only one particular example of computing device 302, and many other examples of computing device 302 may be used in other instances and may include a subset of the components included in example computing device 302 or may include additional components not shown in FIG. 3. Computing device 302 may represent one example of computing device 102 shown in the example of FIG. 1.

As shown in the example of FIG. 3, computing device 302 includes user interface component (UIC) 314, one or more processors 360, one or more communication units 368, and one or more storage devices 370, each of which are interconnected by communication channels 366 (which may be similar to if not the same as communication channels 250 shown in the example of FIG. 2). UIC 314 may be similar to if not the same as UIC 114 shown in the example of FIG. 1. Processors 360 may be similar to if not the same as processors 240 shown in the example of FIG. 2. Communication units 368 may be similar to if not the same as communication units 242 shown in the example of FIG. 2. Storage devices 370 may be similar to if not the same as storage devices 252 shown in the example of FIG. 2.

As further shown in the example of FIG. 3, user interface component 314 may include one or more input components 364 and one or more output components 362. One or more input components 364 of computing device 302 may receive an input. Examples of inputs are tactile, audio, and video input. Input components 364, in one example, includes a presence-sensitive input device (e.g., a touch sensitive screen, a presence-sensitive display), mouse, keyboard, voice responsive system, video camera, microphone or any other type of device for detecting input from a human or machine. In some examples, input components 364 may include one or more sensor components such as one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

One or more output components 362 of computing device 302 may generate output. Examples of output are tactile, audio, and video output. Output components 362 of computing device 302, in one example, includes a PSD, sound card, video graphics adapter card, speaker, cathode ray tube (CRT) monitor, liquid crystal display (LCD), or any other type of device for generating output to a human or machine.

While illustrated as an internal component of computing device 302, UIC 314 may also represent an external component that shares a data path with computing device 302 for transmitting and/or receiving input and output. For instance, in one example, UIC 314 represents a built-in component of computing device 302 located within and physically connected to the external packaging of computing device 302 (e.g., a screen on a mobile phone). In another example, UIC 314 represents an external component of computing device 302 located outside and physically separated from the packaging or housing of computing device 302 (e.g., a monitor, a projector, etc. that shares a wired and/or wireless data path with computing device 302).

One or more storage devices 370 within computing device 302 may store information for processing during operation of computing device 302 (e.g., computing device 302 may store data accessed by UI module 316, application installer 326, patch application unit 336, unpatched application 330A, and patched application 330B during execution by computing device 302). Storage devices 370 may store program instructions and/or information (e.g., data) associated with UI module 316, application installer 326, patch application unit 336, unpatched application 330A, and patched application 330B, all of which may be similar if not substantially similar to UI module 116, application installer 126, patch application unit 136, unpatched application 130A, and patched application 130B of FIG. 1. Storage devices 370 may include a memory configured to store data or other information associated with UI module 316, application installer 326, patch application unit 336, unpatched application 330A, and patched application 330B.

As discussed above, application installer 326 may be executed by processors 360 to install patches at computing device 302. Application installer 326 may perform the functions of an application marketplace application that allows users to interact with application store interface 260 of FIG. 2 via UIC 314 to browse, download, and install patches from an application provider server, such as application provider server 204 shown in the example of FIG. 2.

Specifically, in some examples, after generating patch 248, application provider server 204 may invoke application store interface 260 to interface with computing device 302, via communication units 368, to indicate that patch 248 is available for download. In some examples, UIC 314 of computing device 302 may receive an indication indicative of a request to download patch 348 (which may be similar if not substantially similar to patch 248 of FIG. 2) for unpatched application 330A, and UI module 316 may forward the request to application installer 326. In these examples, responsive to the indication of the request to download patch 348, application installer 326 may send the request for downloading patch 348 to application provider server 204. In other examples, application installer 326 may facilitate auto-updates, e.g., application installer 326 may automatically download patch 348 from application provider server 204 responsive to an indication that patch 348 is available, or responsive to application provider server 204 generating patch 348 (in which, as described with respect to FIG. 2, patch 248 may be generated responsive to application provider server 204 determining that patched application 210B is different from unpatched application 210A). The user of computing device 302 may specify that automatic patching is enabled in system settings or per application, identifying a time and/or day during which automated patching may occur.

In some examples, application installer 326 may receive the entirety of patch 348 or one or more segments of patch 348 in a compressed form in order to potentially further reduce the amount of time required to download patch 348 and further reduce the network resources used in the download. In some examples, patch application unit 336 may be configured to decompress any data received from application provider server 204 and/or stored on computing device 302.

As described herein, patch application unit 336 may receive control file 338 (which may be similar if not substantially similar to control file 238 of FIG. 2) and patch 348 (or segments of patch 348), including commands 354 and diff 356 (which may be similar if not substantially similar to commands 254 and diff 256, respectively, of FIG. 2) from application provider server 204 via communication units 368. Patch application unit 336 may be considered a patch applier configured to read the plurality of encoded step functions included in control file 338 (e.g., string identifiers, method identifiers, file offsets, etc.) and, based on patch 348 (including commands 354 and diff 356) and unpatched application 330A, reproduce mutated unpatched application 110C as mutated unpatched application 330C (which may be similar if not substantially similar to mutated unpatched application 110C). Specifically, patch application unit 336 may be configured to use the plurality of encoded step functions in control file 338 to mutate sequence references in a single pass on unpatched application 330A after decompression (if unpatched application 330A is compressed).

In some examples, patch application unit 336 may apply patching algorithm 374 (which may be a typical general-purpose patching algorithm) to mutated unpatched application 330C. While patch generation unit 218 of FIG. 2 may apply patching algorithm 246 to generate patch 248 (e.g., using generic difference (diff) (“Gdiff”), bsdiff, Xdelta, VCDiff, or any other typical general-purpose patching algorithm), patch application unit 336 may execute patching algorithm 374 to apply patch 348 (in which patching algorithm 374 may be a patching algorithm such as generic patch (Patch), bspatch, Xdelta, VCDiff, or any other typical general-purpose patching algorithm) to mutated unpatched application 330C to produce patched application 330B. In some examples, patch application unit 336 may, upon successful application of patch 348 and installation of patched application 330B, generate a confirmation that application of patch 348 is complete and send the confirmation to application provider server 204. Computing device 302 may generate another confirmation that application of the received patch is complete, outputting the confirmation to a user interface, e.g., a user interface of an application store.

The techniques described herein may remove pointer noise from the resulting patch, and therefore reduce the time complexity of patching. As such, developers of application 110/130 may add additional functionality, fix software errors (so-called “software bugs”), prevent malicious attacks, update graphical capabilities or other functionality, and the like without having to download an entirely new application (which can be large and therefore consume significant bandwidth-both bandwidth of network 108 and memory and/or storage bandwidth of computing device 102, processor cycles of computing device 102, etc.). Additionally, as described herein, control file 338 may include metadata indicating when computing device 302 may delete different portions of unpatched application 330A, thereby potentially enabling computing device 302 to consume even less memory during application of patch 348 (in the form of iterative application of segments of patch 348) as deletion of portions of unpatched application 330A may free up additional memory (or, in other words, increase available memory).

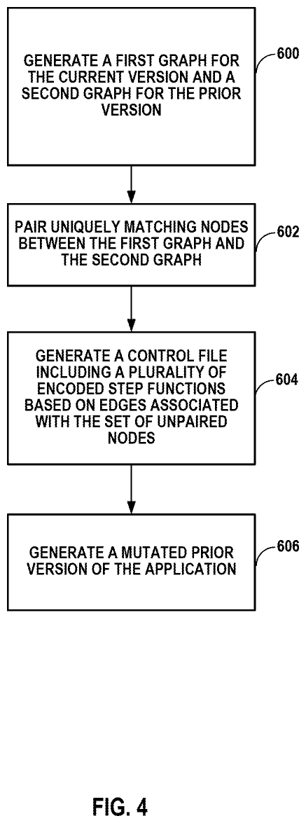

FIG. 4 is a flowchart illustrating an exemplary operation of the computing system shown in the example of FIG. 2, in accordance with techniques of this disclosure. Responsive to determining, by application provider server 204, that patched application 210B is different from unpatched application 210A, application provider server 204 generates graph 224B for patched application 210B and graph 224A for unpatched application 210A (600). Graph 224B may include nodes indicative of data structures in patched application 210B and edges indicative of references in patched application 210B. Graph 224A may include nodes indicative of data structures in unpatched application 210A and edges indicative of references in unpatched application 210A. In some examples, application provider server 204 applies a parser 228 to unpatched application 210A and patched application 210B to generate graph 224A and graph 224B, wherein each of graph 224A and graph 224B is a directed acyclic graph for file formats. Application provider server 204 pairs, using matching algorithm 232, uniquely matching nodes between graph 224A and graph 224B (602). Matching algorithm 232 may be configured to iteratively hash graph 224A and graph 224B, in which a set of unpaired nodes may be updated incrementally with hashes of the paired uniquely matching nodes. In some examples, when application provider server 204 applies matching algorithm 232 to graph 224A and graph 224B to pair uniquely matching nodes, matching algorithm 232 pairs at least two unpaired nodes with uniquely matching successors and pairs at least two unpaired successors of at least two paired uniquely matching nodes. Application provider server 204 generates, using matching algorithm 232, control file 238 including a plurality of encoded step functions based on edges associated with the set of unpaired nodes (604). In some examples, the plurality of encoded step functions indicates one or more differences between the references in unpatched application 210A and the references in patched application 210B.

Application provider server 204 generates, using the plurality of encoded step functions included in control file 238, mutated unpatched application 210C (606). In some examples, to generate mutated unpatched application 210C, application provider server 204 applies the plurality of encoded step functions to the references in unpatched application 210A. In some examples, application provider server 204 applies patching algorithm 246 to mutated unpatched application 210C and patched application 210B to generate patch 248, and sends, to computing device 302, patch 248 and control file 238. In some examples, patching algorithm 246 may be configured to encode one or more differences not between the references in unpatched application 210A and the references in patched application 210B.

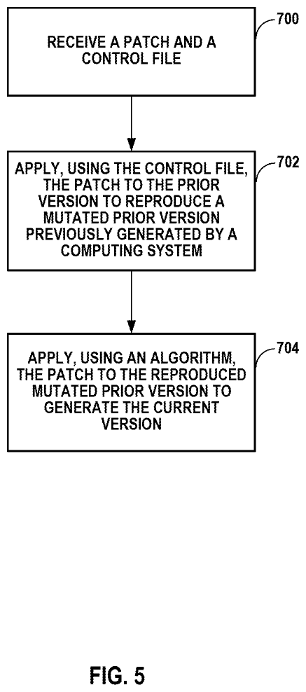

FIG. 5 is a flowchart illustrating an exemplary operation of the computing device shown in the example of FIG. 3, in accordance with techniques of this disclosure. Computing device 302 receives, from application provider server 204, patch 348 and control file 338, wherein control file 338 includes a plurality of encoded step functions indicating one or more differences between a prior version of an application installed at computing device 302 (e.g., unpatched application 330A) and a current version of the application (e.g., patched application 210B) (700). Computing system 302 applies, using control file 338, patch 348 to unpatched application 330A to reproduce mutated unpatched application 210C previously generated by application provider server 204 as reproduced mutated unpatched application 330C (702). In some examples, to apply patch 348 to unpatched application 330A to reproduce the mutated unpatched application 210C, patch application unit 336 reads the plurality of encoded step functions included in control file 338 and mutates, using the plurality of encoded step functions, references in unpatched application 330A. In some examples, the references in unpatched application 330A are mutated in a single pass. In some examples, control file 338 further includes metadata for reproducing mutated prior version 210C. Computing device 302 applies, using patching algorithm 374, patch 348 to reproduce mutated unpatched application 330C to generate the current version (e.g., patched application 330B) (704). In some examples, patching algorithm 374 is a general-purpose patching algorithm. In some examples, responsive to generating patched application 330B, patch application unit 336 may generate a confirmation indicating an application of patch 348 is complete, and send, to application provider server 204, the confirmation. In some examples, computing device 102 may output the confirmation to a user interface of an application store.

This disclosure includes the following examples.

Example 1. A method comprising: responsive to determining, by a computing system, that a current version of an application is different from a prior version of the application installed at a computing device, generating, by the computing system, a first graph for the current version of the application and a second graph for the prior version of the application, wherein the first graph includes nodes indicative of data structures in the current version and edges indicative of references in the current version, and wherein the second graph includes nodes indicative of data structures in the prior version and edges indicative of references in the prior version; pairing, by the computing system and using an algorithm, uniquely matching nodes between the first graph and the second graph, wherein the algorithm is configured to iteratively hash the first graph and the second graph, and wherein a set of unpaired nodes are updated incrementally with hashes of the paired uniquely matching nodes; generating, by the computing system and using the algorithm, a control file including a plurality of encoded step functions based on edges associated with the set of unpaired nodes; and generating, by the computing system and using the plurality of encoded step functions included in the control file, a mutated prior version of the application.

Example 2. The method of example 1, wherein generating the mutated prior version further comprises applying the plurality of encoded step functions to the references in the prior version.

Example 3. The method of any of examples 1-2, wherein the plurality of encoded step functions indicates one or more differences between the references in the prior version of the application and the references in the current version of the application.

Example 4. The method any of examples 1-3, wherein the algorithm is a first algorithm, the method further comprising: applying, by the computing system, a second algorithm to the mutated prior version and the current version to generate a patch; and sending, to the computing device, the patch and the control file.

Example 5. The method of example 4, wherein the second algorithm is configured to encode one or more differences not between the references in the prior version and the references in the current version.

Example 6. The method of example 4, wherein the second algorithm is a general purpose patching algorithm.

Example 7. The method of example 4, wherein the control file further includes information for reproducing the mutated prior version.

Example 8. The method of any of examples 1-7, wherein the algorithm is a matching algorithm.

Example 9. The method of any of examples 1-8, further comprising: applying, by the computing system, a parser to the prior version and the current version to generate the first graph and the second graph, wherein each of the first graph and the second graph is a directed acyclic graph for file formats.

Example 10. The method of any of examples 1-9, wherein applying the algorithm to the first graph and the second graph to pair uniquely matching nodes further comprises: pairing, by the computing system and using the algorithm, at least two unpaired nodes with uniquely matching successors; and pairing, by the computing system and using the algorithm, at least two unpaired successors of at least two paired uniquely matching nodes.

Example 11. A computing system comprising: a memory; and one or more processors configured to: responsive to determining that a current version of an application is different from a prior version of the application installed at a computing device, generate a first graph for the current version of the application and a second graph for the prior version of the application, wherein the first graph includes nodes indicative of data structures in the current version and edges indicative of references in the current version, and wherein the second graph includes nodes indicative of data structures in the prior version and edges indicative of references in the prior version; pair, using an algorithm, uniquely matching nodes between the first graph and the second graph, wherein the algorithm is configured to iteratively hash the first graph and the second graph, and wherein a set of unpaired nodes are updated incrementally with hashes of the paired uniquely matching nodes; generate, using the algorithm, a control file including a plurality of encoded step functions based on edges associated with the set of unpaired nodes; and generate, using the plurality of encoded step functions included in the control file, a mutated prior version of the application.

Example 12. The computing system of example 11, wherein to generate the mutated prior version, the one or more processors are further configured to apply the plurality of encoded step functions to the references in the prior version.

Example 13. The computing system of any of examples 11-12, wherein the plurality of encoded step functions indicates one or more differences between the references in the prior version and the references in the current version.

Example 14. The computing system of any of examples 11-13, wherein the algorithm is a first algorithm, and wherein the one or more processors are further configured to: apply a second algorithm to the mutated prior version and the current version to generate a patch; and send, to the computing device, the patch and the control file.

Example 15. The computing system of example 14, wherein the second algorithm is configured to encode one or more differences not between the references in the prior version and the references in the current version.

Example 16. The computing system of example 14, wherein the first algorithm is a matching algorithm.

Example 17. The computing system of example 14, wherein the second algorithm is a patching algorithm.

Example 18. The computing device of example 14, wherein the control file further includes information for reproducing the mutated prior version.

Example 19. The computing system of any of examples 11-18, wherein the one or more processors are further configured to: apply a parser to the prior version and the current version to generate the first graph and the second graph, wherein each of the first graph and the second graph is a directed acyclic graph for file formats.

Example 20. The computing system of any of examples 11-19, wherein to apply the algorithm to the first graph and the second graph to pair uniquely matching nodes, the one or more processors are further configured to: pair, using the algorithm, at least two unpaired nodes with uniquely matching successors; and pair, using the algorithm, at least two unpaired successors of at least two paired uniquely matching nodes.

Example 21. A computer-readable storage medium encoded with instructions that, when executed by one or more processors of a computing system, cause the one or more processors to: responsive to determining that a current version of an application is different from a prior version of the application installed at a computing device, generate a first graph for the current version of the application and a second graph for the prior version of the application, wherein the first graph includes nodes indicative of data structures in the current version and edges indicative of references in the current version, and wherein the second graph includes nodes indicative of data structures in the prior version and edges indicative of references in the prior version; pair, using an algorithm, uniquely matching nodes between the first graph and the second graph, wherein the algorithm is configured to iteratively hash the first graph and the second graph, and wherein a set of unpaired nodes are updated incrementally with hashes of the paired uniquely matching nodes; generate, using the algorithm, a control file including a plurality of encoded step functions based on edges associated with the set of unpaired nodes; and generate, using the plurality of encoded step functions included in the control file, a mutated prior version of the application.

Example 22. The computer-readable storage medium of example 21, wherein to generate the mutated prior version, the one or more processors are further configured to apply the plurality of encoded step functions to the references in the prior version, wherein the plurality of encoded step functions indicates one or more differences between the references in the prior version and the references in the current version.

Example 23. The computer-readable storage medium of any of examples 21-22, wherein the algorithm is a first algorithm, and wherein the one or more processors are further configured to: apply a second algorithm to the mutated prior version and the current version to generate a patch, wherein the second algorithm is a patching algorithm, and wherein the second algorithm is configured to encode one or more differences not between the references in the prior version and the references in the current version; and send, to the computing device, the patch and the control file.

Example 24. The computer-readable storage medium of any of examples 21-23, wherein to apply the algorithm to the first graph and the second graph to pair uniquely matching nodes, the one or more processors are further configured to: pair, using the algorithm, at least two unpaired nodes with uniquely matching successors; and pair, using the algorithm, at least two unpaired successors of at least two paired uniquely matching nodes.

Example 25. A method comprising: receiving, by a computing device and from a computing system, a patch and a control file, wherein the control file includes a plurality of encoded step functions indicating one or more differences between a prior version of an application installed at the computing device and a current version of the application; applying, by the computing device and using the control file, the patch to the prior version to reproduce a mutated prior version previously generated by the computing system; and applying, by the computing device and using an algorithm, the patch to the reproduced mutated prior version to generate the current version.

Example 26. The method of example 25, wherein the algorithm is a general-purpose patching algorithm.

Example 27. The method of any of examples 25-26, wherein applying the patch to the prior version to reproduce the mutated prior version further comprises: reading, by the computing device, the plurality of encoded step functions included in the control file; and mutating, by the computing device and using the plurality of encoded step functions, references in the prior version.

Example 28. The method of example 27, wherein the references in the prior version are mutated in a single pass.

Example 29. The method of any of examples 25-28, wherein the control file further includes metadata for reproducing the mutated prior version.

Example 30. The method of any of examples 25-29, further comprising: responsive to generating the current version, generating, by the computing device, a confirmation indicating an application of the patch is complete; and sending, to the computing system, the confirmation.

Example 31. The method of example 30, further comprising outputting, by the computing device, the confirmation to a user interface of an application store.

Example 32. A computing device comprising: a memory; and one or more processors configured to: receive, from a computing system, a patch and a control file, wherein the control file includes a plurality of encoded step functions indicating one or more differences between a prior version of an application installed at the computing device and a current version of the application; apply, using the control file, the patch to the prior version to reproduce a mutated prior version previously generated by the computing system; and apply, using an algorithm, the patch to the reproduced mutated prior version to generate the current version.

Example 33. The computing device of example 32, wherein the algorithm is a general-purpose patching algorithm.

Example 34. The computing device of any of examples 32-33, wherein to apply the patch to the prior version to reproduce the mutated prior version, the one or more processors are further configured to: read the plurality of encoded step functions included in the control file; and mutate, using the plurality of encoded step functions, references in the prior version.

Example 35. The computing device of example 34, wherein the references in the prior version are mutated in a single pass.

Example 36. The computing device of any of examples 32-35, wherein the control file further includes metadata for reproducing the mutated prior version.

Example 37. The computing device of any of examples 32-36, wherein the one or more processors are further configured to: responsive to generating the current version, generate a confirmation indicating an application of the patch is complete; and send, to the computing system, the confirmation.

Example 38. The computing device of example 37, wherein the one or more processors are further configured to output the confirmation to a user interface of an application store.

Example 39. A computer-readable storage medium encoded with instructions that, when executed by one or more processors of a computing device, cause the one or more processors to: receive, from a computing system, a patch and a control file, wherein the control file includes a plurality of encoded step functions indicating one or more differences between a prior version of an application installed at the computing device and a current version of the application; apply, using the control file, the patch to the prior version to reproduce a mutated prior version previously generated by the computing system; and apply, using an algorithm, the patch to the reproduced mutated prior version to generate the current version.

Example 40. The computer-readable storage medium of example 39, wherein the algorithm is a general-purpose patching algorithm.

Example 41. The computer-readable storage medium of any of examples 39-40, wherein to apply the patch to the prior version to reproduce the mutated prior version, the one or more processors are further configured to: read the plurality of encoded step functions included in the control file; and mutate, using the plurality of encoded step functions, references in the prior version.

Example 42. The computer-readable storage medium of example 41, wherein the references in the prior version are mutated in a single pass.

Example 43. The computer-readable storage medium of any of examples 39-42, wherein the control file further includes metadata for reproducing the mutated prior version.

Example 44. The computer-readable storage medium of any of examples 39-43, wherein the one or more processors are further configured to: responsive to generating the current version, generate a confirmation indicating an application of the patch is complete; and send, to the computing system, the confirmation.

Example 45. The computer-readable storage medium of example 44, wherein the one or more processors are further configured to output the confirmation to a user interface of an application store.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of a computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

Various examples have been described. These and other examples are within the scope of the following claims.

What is claimed is:

1. A method comprising:
responsive to determining, by a computing system, that a current version of an application is different from a prior version of the application installed at a computing device, generating, by the computing system, a first graph for the current version of the application and a second graph for the prior version of the application, wherein the first graph includes nodes indicative of data structures in the current version and edges indicative of references in the current version, and wherein the second graph includes nodes indicative of data structures in the prior version and edges indicative of references in the prior version;
pairing, by the computing system and using an algorithm, uniquely matching nodes between the first graph and the second graph, wherein the algorithm is configured to iteratively hash the first graph and the second graph, and wherein a set of unpaired nodes are updated incrementally with hashes of the paired uniquely matching nodes;
generating, by the computing system and using the algorithm, a control file including a plurality of encoded step functions based on edges associated with the set of unpaired nodes; and
generating, by the computing system and using the plurality of encoded step functions included in the control file, a mutated prior version of the application.

2. The method of claim 1, wherein generating the mutated prior version further comprises applying the plurality of encoded step functions to the references in the prior version.

3. The method of claim 1, wherein the plurality of encoded step functions indicates one or more differences between the references in the prior version of the application and the references in the current version of the application.

4. The method of claim 1, wherein the algorithm is a first algorithm, the method further comprising:
applying, by the computing system, a second algorithm to the mutated prior version and the current version to generate a patch; and
sending, to the computing device, the patch and the control file.

5. The method of claim 4, wherein the control file further includes information for reproducing the mutated prior version.

6. The method of claim 4, wherein the first algorithm is a matching algorithm, wherein second algorithm is a general-purpose patching algorithm, and wherein the second algorithm is configured to encode one or more differences not between the references in the prior version and the references in the current version.

7. The method of claim 1, further comprising:
applying, by the computing system, a parser to the prior version and the current version to generate the first graph and the second graph, wherein each of the first graph and the second graph is a directed acyclic graph for file formats.

8. The method of claim 1, wherein applying the algorithm to the first graph and the second graph to pair uniquely matching nodes further comprises:
pairing, by the computing system and using the algorithm, at least two unpaired nodes with uniquely matching successors; and
pairing, by the computing system and using the algorithm, at least two unpaired successors of at least two paired uniquely matching nodes.

9. A computing system comprising:
a memory; and
one or more processors configured to:
responsive to determining that a current version of an application is different from a prior version of the application installed at a computing device, generate a first graph for the current version of the application and a second graph for the prior version of the application, wherein the first graph includes nodes indicative of data structures in the current version and edges indicative of references in the current version, and wherein the second graph includes nodes indicative of data structures in the prior version and edges indicative of references in the prior version;
pair, using an algorithm, uniquely matching nodes between the first graph and the second graph, wherein the algorithm is configured to iteratively hash the first graph and the second graph, and wherein a set of unpaired nodes are updated incrementally with hashes of the paired uniquely matching nodes;
generate, using the algorithm, a control file including a plurality of encoded step functions based on edges associated with the set of unpaired nodes; and
generate, using the plurality of encoded step functions included in the control file, a mutated prior version of the application.

10. The computing system of claim 9, wherein to generate the mutated prior version, the one or more processors are further configured to apply the plurality of encoded step functions to the references in the prior version.

11. The computing system of claim 9, wherein the plurality of encoded step functions indicates one or more differences between the references in the prior version and the references in the current version.

12. The computing system of claim 9, wherein the algorithm is a first algorithm, and wherein the one or more processors are further configured to:
apply a second algorithm to the mutated prior version and the current version to generate a patch; and
send, to the computing device, the patch and the control file.

13. The computing system of claim 12, wherein the control file further includes information for reproducing the mutated prior version.

14. The computing system of claim 12, wherein the first algorithm is a matching algorithm, wherein the second algorithm is a patching algorithm, and wherein the second algorithm is configured to encode one or more differences not between the references in the prior version and the references in the current version.

15. The computing system of claim 9, wherein the one or more processors are further configured to:
apply a parser to the prior version and the current version to generate the first graph and the second graph, wherein each of the first graph and the second graph is a directed acyclic graph for file formats.

16. The computing system of claim 9, wherein to apply the algorithm to the first graph and the second graph to pair uniquely matching nodes, the one or more processors are further configured to:
pair, using the algorithm, at least two unpaired nodes with uniquely matching successors; and
pair, using the algorithm, at least two unpaired successors of at least two paired uniquely matching nodes.

17. A computer-readable storage medium encoded with instructions that, when executed by one or more processors of a computing system, cause the one or more processors to:
responsive to determining that a current version of an application is different from a prior version of the application installed at a computing device, generate a first graph for the current version of the application and a second graph for the prior version of the application, wherein the first graph includes nodes indicative of data structures in the current version and edges indicative of references in the current version, and wherein the second graph includes nodes indicative of data structures in the prior version and edges indicative of references in the prior version;
pair, using an algorithm, uniquely matching nodes between the first graph and the second graph, wherein the algorithm is configured to iteratively hash the first graph and the second graph, and wherein a set of unpaired nodes are updated incrementally with hashes of the paired uniquely matching nodes;
generate, using the algorithm, a control file including a plurality of encoded step functions based on edges associated with the set of unpaired nodes; and
generate, using the plurality of encoded step functions included in the control file, a mutated prior version of the application.

18. The computer-readable storage medium of claim 17, wherein to generate the mutated prior version, the one or more processors are further configured to apply the plurality of encoded step functions to the references in the prior version, wherein the plurality of encoded step functions indicates one or more differences between the references in the prior version and the references in the current version.

19. The computer-readable storage medium of claim 17, wherein the algorithm is a first algorithm, and wherein the one or more processors are further configured to:
apply a second algorithm to the mutated prior version and the current version to generate a patch, wherein the second algorithm is a patching algorithm, and wherein the second algorithm is configured to encode one or more differences not between the references in the prior version and the references in the current version; and
send, to the computing device, the patch and the control file.

20. The computer-readable storage medium of claim 17, wherein to apply the algorithm to the first graph and the second graph to pair uniquely matching nodes, the one or more processors are further configured to:
pair, using the algorithm, at least two unpaired nodes with uniquely matching successors; and
pair, using the algorithm, at least two unpaired successors of at least two paired uniquely matching nodes.

21. A method comprising:
receiving, by a computing device and from a computing system, a patch and a control file, wherein the control file includes a plurality of encoded step functions indicating one or more differences between a prior version of an application installed at the computing device and a current version of the application;
applying, by the computing device and using the control file, the patch to the prior version to reproduce a mutated prior version previously generated by the computing system; and
applying, by the computing device and using an algorithm, the patch to the reproduced mutated prior version to generate the current version.
